(19) United States
(12) Patent Application Publication
(10) Pub. No.: US 2006/0260230 A1
(43) Pub. Date: Nov. 23, 2006

(54) Architectural detailing assembly method and apparatus

(76) Inventors: Michael W. LeBlanc, Mission (CA); Richard M. Patterson, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/114,331

(22) Filed: Apr. 25, 2005

(51) Int. Cl. E06B 1/04

(52) U.S. Cl. 52/211

(57) ABSTRACT

An architectural detailing assembly (10) and a method of forming an architectural detailing assembly. The architectural detailing assembly includes an architectural detailing (12 or 14) having a length terminating in an end surface (22), and an appearance surface (28) adapted to be viewed by a user once installed upon a building structure and having a predetermined profile. The architectural detailing also includes a spacer (16) having a first planar wall (38) adapted to be selectively coupled to the end surface of the architectural detailing and a second planar wall (40) oriented substantially parallel with the first planar wall and separated from the first planar wall by a thickness. The spacer includes a sealant backing surface (45) oriented substantially perpendicular to and extending between the first and second planar walls. The sealant backing surface is shaped to substantially have the predetermined profile.

The present invention relates generally to architectural detailings and, more particularly, to spacers for spacing an architectural detailing from another object.

### BACKGROUND OF THE INVENTION

An architectural detailing can transform a standard doorway into a grand archway and a fireplace mantle into a room's centerpiece. Finishing touches such as moldings and cornices are widely used in the homebuilding industry as a way to increase the aesthetic and economic value of a home. To obtain market share and to establish a reputation, builders are seeking out variations on classic architectural detailings.

In the recent past, architectural detailings were typically formed from stone/concrete or wood. With a number of advancements made within the foam industry, many builders are now utilizing pre-coated foam architectural detailings. One reason for their popularity is that they have a similar look and feel to precast, natural stone products, or wood, at the same time providing a significant reduction in raw material and installation costs. The foam architectural detailings are also being used to accommodate climates adverse to wood and to offset rising wood costs.

In a typical construction, a mesh is applied to a foam core, then it is coated and topped with a stone like or other finish to create a product that is strong and aesthetically pleasing. The resulting product may be one-tenth the weight of precast stone. Further, the resultant product is easier and costs less money to install. It can be made in any shape and size. The manufacturing time is considerably less as well, and the cost is around 40 percent less for the installation of a foam product versus a precast product.

The foam core is easily formed into any shape, allowing designers wide latitude in designing the shape of the architectural detailing. The design aspects for coated foam products are infinite and have become extremely popular with architects and interior designers alike. The foam is dimensionally stable, resistant to expansion, contraction, warping, rotting and twisting. Additionally the foam is not a nutrient source for insects, which is important in humid and termite-prone climates.

Although previously developed faux architectural detailings are effective, they are not without their problems. It has been discovered that a significant amount of time and labor is used in sealing the ends of the faux architectural detailings to an adjacent object, such as another faux architectural detailing, wall, ceiling, etc. Moreover, it has been found that consistently obtaining the correct spacing between the end of the faux architectural detailing and the adjacent object has been problematic. Further, there is a large void between the end of the faux architectural detailing and the object, the void necessary to allow for expansion. This void is hard to seal since there is no backing for a sealant to rest against during application. Therefore, either the entire void must be filled with the sealant material, or strips of backing material or other suitable material stuffed into the void to provide backing for the sealant. This is a laborious process as first the correct spacing must be measured and set, and then the void custom filled with the backing material. Therefore, there exists a need for a method and/or apparatus for facilitating the setting of the correct spacing between an end of an architectural detailing and an object, and/or providing backing material for the sealant that will be applied in the void to seal the architectural detailing to the object.

### SUMMARY OF THE INVENTION

One embodiment of a spacer formed in accordance with the present invention for attachment to an end of an architectural detailing to space the architectural detailing from an object is disclosed. The spacer includes a block of material having a thickness defined by a distance separating a first planar wall of the block from a second planar wall of the block. The first and second planar walls are oriented substantially parallel to one another, the block having a sealant backing surface oriented substantially perpendicular to and extending between the first and second planar walls. The block is adapted to be attached to an end of an architectural detailing to space the architectural detailing from another object by the thickness of the block.

An embodiment of architectural detailing assembly formed in accordance with the present invention is disclosed. The architectural detailing assembly includes an architectural detailing having a length terminating in an end surface and an appearance surface adapted to be viewed by a user once installed upon a building structure. The appearance surface has a predetermined profile. The architectural detailing assembly also includes a spacer having a first planar wall adapted to be selectively coupled to the end surface of the architectural detailing and a second planar wall oriented substantially parallel with the first planar wall and separated from the first planar wall by a thickness. The spacer includes a sealant backing surface oriented substantially perpendicular to and extending between the first and second planar walls. The sealant backing surface is shaped to substantially have the predetermined profile.

One embodiment of a method of forming an architectural detailing assembly in accordance with the present invention is disclosed. The method includes extruding a first core having a predetermined profile and covering at least one surface of the first core with a finish material to enlarge the predetermined profile of the first core to a selected profile. The method also includes extruding a second core having the predetermined profile and a length and cutting the second core substantially perpendicular to its length to form one or more spacers having the predetermined profile.

Another embodiment of a method of forming an architectural detailing assembly in accordance with the present invention is disclosed. The method includes attaching an architectural detailing to a structure, the architectural detailing having a core which has a predetermined profile and a covering applied to at least a portion of an outer surface of the first core which enlarges the predetermined profile to a preselected profile. The method also includes coupling a spacer having substantially the predetermined profile to an end surface of the architectural detailing and placing a sealant upon the spacer and architectural detailing to seal the architectural detailing to the spacer.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is an exploded perspective view of one embodiment of an architectural detailing assembly formed in accordance with the present invention, wherein the architectural detailing assembly is shown with a pair of architectural detailings shown spaced apart from one another with a spacer disposed therebetween;

FIG. 2 is an assembled perspective view of the architectural detailing assembly of FIG. 1 prior to application of a sealant material;

FIG. 3 is a perspective view of the architectural detailing assembly of FIG. 1 as the sealant material is being applied to the spacer; and

FIG. 4 is a cross-sectional elevation right side view of the architectural detailing assembly after a cross-sectional cut has been taken through the spacer along Section 4-4 of FIG. 3.

### DETAILED DESCRIPTION OF THE PREFERRED EMBODIMENT

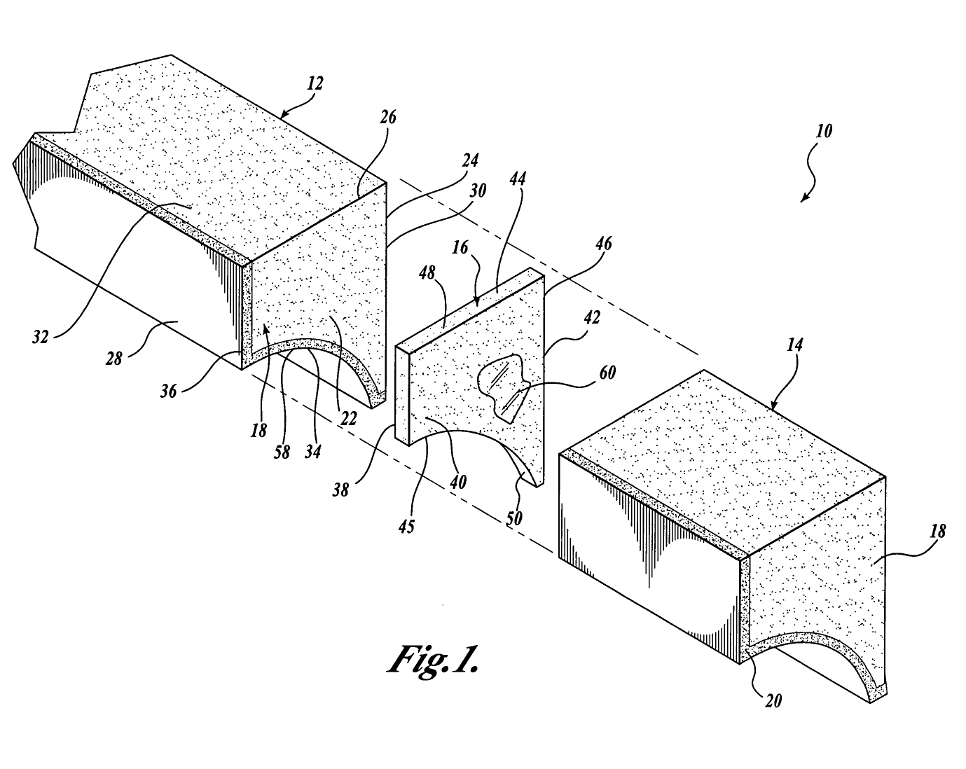

One embodiment of an architectural detailing assembly 10 formed in accordance with the present invention is depicted in FIG. 1. The architectural detailing assembly 10 includes a first architectural detailing 12 spaced from a second architectural detailing 14 by a spacer 16. The architectural detailings 12 and 14 may take many shapes/forms as is well known in the art. More specifically, architectural detailings formed in accordance with the present invention may take forms suitable for use in any application wherein a user wishes to enhance the appearance of a structure, a few examples being for use as sills, molding, window and door trim, banding, cornices, parapets, columns, caps, risers, keystones, quoins, etc. Although the architectural detailings shown and described in this detailed description are faux architectural detailings formed from extruded material designed to resemble a selected material, it should be apparent to those skilled in the art the architectural detailings may alternately be made from the true material, such as from wood, stone, stucco, etc.

Inasmuch as the architectural detailings 12 and 14 are identical to one another in the illustrated embodiment, this detailed description, for the sake of brevity, will describe only one of the architectural detailings in detail, with those skilled in the art appreciating that the description of the one architectural detailing applies equally well to the other architectural detailing.

Preferably, each of the architectural detailings 12 and 14 includes a lightweight core 18, preferably made from an extrudable material, such as a Type I or Type II expanded polystyrene (EPS) foam. Preferably, the core 18 is coated with a coating material 20, suitably formed from a single material or a plurality of materials, such as a plurality of materials applied in a plurality of layers or a mixture of materials applied in a single layer as is well known in the art. The core 18 may be painted or factory finished with the coating material 20, such as an acrylic, in different textures and colors. Preferably, the coating 20 is pre-applied prior to installation, such as applied by the manufacturer. The coating 20 may be applied in a liquid form and then allowed to cure into a solid. The coating 20 provides a pleasing finish to the architectural detailings 12 and 14, protects the lightweight core 18, repels moisture, etc.

The illustrated architectural detailing 12 is an elongate member having a length and a cross-sectional profile that is substantially constant along the length of the architectural detailing 12. The architectural detailing 12 includes the core 18 and coating 20 as mentioned above. The architectural detailing 12 includes a planar riser wall 30 and a planar top wall 32 oriented perpendicular to one another, such as to permit the architectural detailing 12 to be placed along the intersection of two perpendicular planar surfaces, such as at the intersection of a wall and a ceiling. Connecting the riser and top walls 30 and 32 is an appearance surface 28 having a predetermined shape. The appearance surface 28 is adapted to be viewed by a user once the architectural detailing 12 is coupled to a building structure, and as such, often includes one or more non-linear or curved portions 34 to provide an aesthetically pleasing appearance. The appearance surface 28 is preferably completely covered in the coating material 20 to provide an aesthetically and texturally pleasing surface.

The architectural detailing 12 terminates in an end surface 22 preferably located perpendicularly to the length of the architectural detailing 12, although other angles are within the spirit and scope of the present invention, one suitable example being orientating the end surface 22 at a 45 degree angle to the length of the architectural detailing 12 such that two architectural detailings can meet and abut at a 90 degree corner. Turning to FIG. 1, the end surface 22 includes a perimeter defined by a riser edge 24 and a top edge 26 located perpendicular to one another, and an appearance edge 58 extending between the riser edge 24 and the top edge 26. The riser edge 24, top edge 26, and appearance edge 58 are all the end edges of their respective walls or surface, i.e. the riser wall 30, top wall 32, and appearance surface 28 respectively.

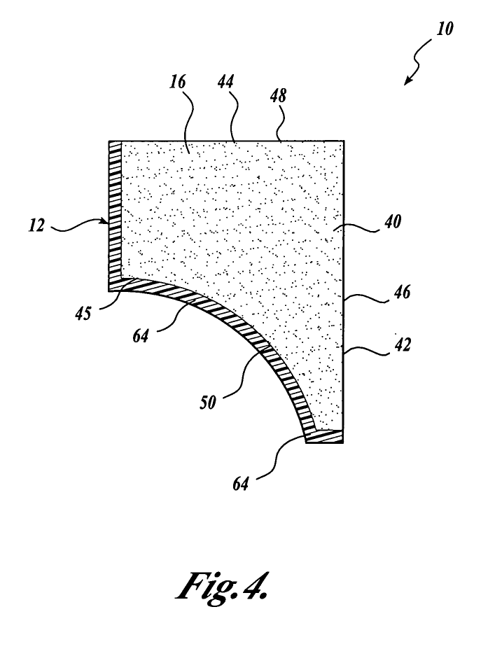

Turning to FIGS. 1 and 4, the spacer 16 will now be described in detail. The spacer 16 is a thin member having a cross-sectional profile that is substantially constant along a thickness of the spacer 16. The spacer 16 includes a first planar wall 38 (see FIG. 1) and a second planar wall 40 oriented parallel to the first planar wall 38. The first and second planar walls 38 and 40 are spaced from one another by a distance equal to the thickness of the spacer 16. Extending between the first and second planar walls 38 and 40 and oriented perpendicular thereto are a planar riser wall 46, a planar top wall 48, and a sealant backing wall 50. The riser and top walls 46 and 48 are oriented perpendicular to one another, such as to permit the spacer 16 to be placed along the intersection of two perpendicular planar surfaces, for instance at the intersection of a wall and a ceiling. The sealant backing wall 50 connects the riser and top walls 46 and 48 and preferably has a preselected shape that substantially matches the predetermined shape of the appearance surface 28 of the architectural detailing 12. The sealant backing wall 50 is adapted to be offset inward from the appearance surface 28 a predetermined distance such that a sealant compound 64, such as a mortar or caulking material, can be applied upon the sealant backing wall 50 and built up to about the same height as the appearance surface 28 of the architectural detailing 12, as will be described in more detail below.

The first and second planar surfaces 38 and 40 each include a perimeter defined by, as shown for the second planar surface, a riser edge 42 and a top edge 44, each located perpendicular to one another, with a sealant backing edge 45 extending between the riser edge 42 and the top edge 44. The riser edge 42, top edge 44, and the sealant backing edge 45 are all the end edges of their respective walls or surface, i.e. the riser wall 46, top wall 48, and sealant backing surface 50 respectively. Since the first and second planar surfaces 38 and 40 are identical to one another, their perimeters are also identical. Therefore, only the perimeter of the second planar surface 40 will be specifically described herein for the sake of brevity.

Of note, the second planar surface 40 is nearly identical, but not exactly identical, in shape to the end surface 22 of the architectural detailing 12. Moreover, the surface area of the second planar surface 40 is less than the surface area of the end surface 22 such that when the spacer 16 is coupled to the architectural detailing 12, the perimeter of the second planar surface 40 does not match perfectly with the perimeter of the end surface 22 and has at least one edge that is offset inward from a corresponding edge of the end surface 22. The difference in perimeters permits the sealant backing surface 50 of the spacer 16 to be offset inward relative to the appearance surface 28 to provide a step downward where the end surface 22 abuts the first planar surface 38, the step being from the appearance surface 28 down to the sealant backing surface 50. This difference in height is later filled in with a sealant compound 64 as will be described in more detail below. In the illustrated embodiment, the surface area of the second planar surface 40 is greater than about 70% of the surface area of the end surface 22, but less than 100% of the surface area of the end surface 22. In other embodiments, the surface area of the second planar surface 40 is greater than about 80% or 90% of the surface area of the end surface 22, but les than 100% of the surface area of the end surface 22.

Of note, the second planar surface 40 of the illustrated embodiment has a shape in one embodiment that is identical to the end surface 22 of the architectural detailing 12 prior to application of the coating 20, i.e. the end surface of the core 18 prior to application of the coating 20 is identical in shape to the second planar surface 40. The application of the coating 20 builds up and increases the perimeter size of the end surface 22, thereby creating the difference in perimeters of the second planar surface 40 and the end surface 22. In the illustrated embodiment, the core 18 and the spacer 16 are formed from the same material. Thus, the spacer 16 is made from a lightweight, extrudable material, such as a Type I or Type II expanded polystyrene (EPS) foam material, which is flexible and able to absorb thermal contractions and expansions in the length of the architectural detailings 12 and 14.

In one embodiment, the spacer 16 is made by cutting a core 18 prior to application of the coating 20 or a second core having the same shape as the core 18. This way, the spacer 16 has the same cross-sectional shape as the core 18 of the architectural detailings 12 and 14. For instance, in one embodiment of the present invention, an architectural detailing 12 is formed by extruding a core 18 having the desired shape and length, while simultaneously coating the appearance surface 28 with the coating 20 during extrusion. A second core is then extruded having the same shape as the first core 18. The coating material is not applied to the second core. The second core is then cut transversely to the length of the core at selected intervals to make spacers 16 of a selected thickness. Preferably, the thickness of the spacers 16 is one inch or less, however it should be apparent to those skilled in the art that spacers 16 having a thickness greater than one inch are within the spirit and scope of the present invention.

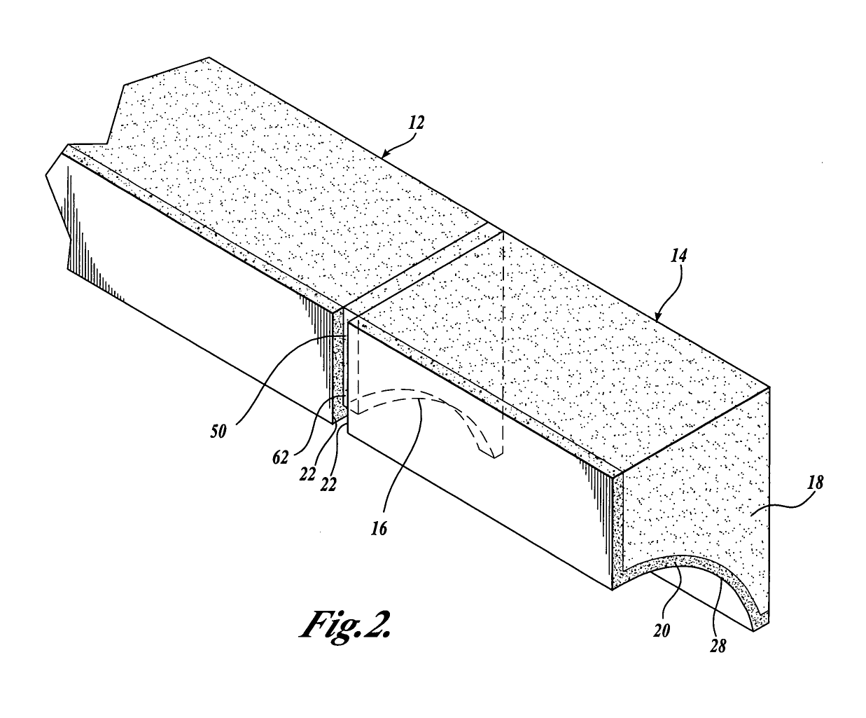

Still referring to FIG. 1, in light of the above description of the physical structure of the architectural detailing assembly 10, the installation of the architectural detailing assembly 10 will now be described. An adhesive 60 is applied to the end surfaces 22 of the architectural detailings 12 and 14 and/or the first and second planar surfaces 38 and 40 of the spacer 16. The spacer 16 is then attached to the end surfaces 22 such that the riser and top walls 30 and 32 of the architectural detailings 12 and 14 are coplanar with the riser and top walls 46 and 48 of the spacer 16. Referring to FIG. 2, arranged as described, a channel 62 is formed between the architectural detailings 12 and 14. The channel 62 extends the length of the appearance surface 28 and is offset inward from the appearance surface 28 by a predetermined amount, such as an amount greater than about 1/32 of an inch and less than about one inch. In other embodiments, the offset or depth of the channel 62 is less than about ¾ inch, ½ inch, ¼ inch, or 3/16 inch.

The bottom of the channel 62 is defined by the sealant backing surface 50 and the sides of the channel 62 are defined by the portions of the end surfaces 22 extending above the sealant backing surface 50. In the illustrated embodiment, the depth of the channel 62 is equal to the thickness of the coating 20 applied to the core 18, since the spacer 16 has an identical cross-sectional shape relative to the cross-sectional shape of the core 18. Thus, the offset or depth of the channel 62 varies according to the thickness of the coating 20 applied. However, it should be apparent to those skilled in the art, that although the spacer 16 is illustrated and described as having an identical cross-sectional shape to that of the core 18 of the architectural detailings 12 and 14, the spacer 16 may have cross-sectional shapes which are not identical to the cross-sectional shape of the architectural detailings 12 and 14. However, it is preferred that the perimeter of the spacer 16 not extended outward of the perimeter of the end surface 22.

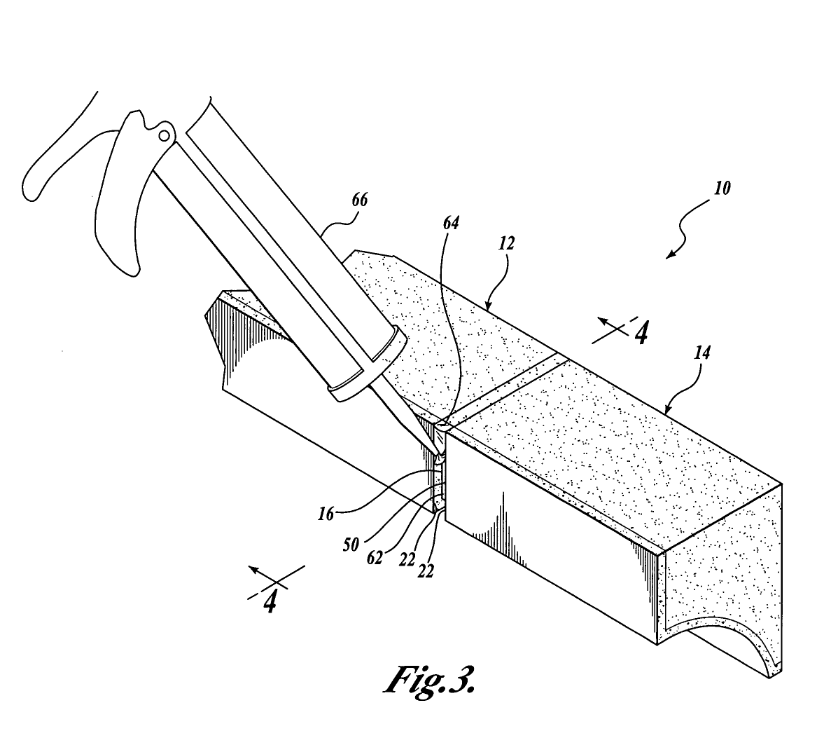

Turning to FIG. 3, once the spacer 16 is sandwiched between the architectural detailings 12 and 14, a user applies a sealant compound 64 via a sealant applicator 66 or other similar device within the channel 62 to seal the architectural detailings 12 and 14 to one another. The sealant backing surface 50 acts as a back stop to provide support for the sealant 64 during application such that the entire void between the end surfaces 22 of the architectural detailings 12 and 14 does not need to be filled by sealant. Inasmuch as the spacer 16 and sealant 64 are flexible materials, any expansion and contraction of the architectural detailings can be accommodated through expansion and contraction of the spacer 16 and sealant 64.

Although the above illustrated and described architectural detailing assembly is described as using a spacer for separating a first architectural detailing from a second architectural detail, it should be apparent to those skilled in the art that the spacer may be used to selectively space an architectural detailing from any object, which may include a second architectural detail, or may be any other object, such as a wall, floor, ceiling, etc.

Further, although a single spacer is illustrated and described as being disposed between adjacent architectural detailings, it is noted that if a wider channel is desired between adjacent architectural detailings, a plurality of spacers may be disposed between the adjacent architectural detailings.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A spacer adapted to be attached to an end of an architectural detailing to space the architectural detailing from an object, the spacer comprising:
a block of material having a thickness defined by a distance separating a first planar wall of the block from a second planar wall of the block, the first and second planar walls oriented substantially parallel to one another, the block having a sealant backing surface oriented substantially perpendicular to and extending between the first and second planar walls, the block adapted to be attached to an end of an architectural detailing to space the architectural detailing from another object by the thickness of the block.

2. The spacer of claim 1, wherein the material forming the block is an extruded material.

3. The spacer of claim 1, wherein the material forming the block is foam.

4. The spacer of claim 1, wherein the block includes a first planar surface oriented substantially perpendicular to and extending between the first and second planar walls and a second planar surface oriented substantially perpendicular to and extending between the first and second planar walls and oriented substantially perpendicular to the first planar surface.

5. The spacer of claim 1, wherein the thickness of the block is less than one inch.

6. The spacer of claim 1, wherein the sealant backing surface is a contoured surface wherein at least a portion of the sealant backing surface is curved.

7. An architectural detailing assembly comprising:
(a) an architectural detailing having a length terminating in an end surface, and an appearance surface adapted to be viewed by a user once installed upon a building structure, the appearance surface having a predetermined profile; and
(b) a spacer having a first planar wall adapted to be selectively coupled to the end surface of the architectural detailing and a second planar wall oriented substantially parallel with the first planar wall and separated from the first planar wall by a thickness, wherein the spacer includes a sealant backing surface oriented substantially perpendicular to and extending between the first and second planar walls, wherein the sealant backing surface is shaped to substantially have the predetermined profile.

8. The architectural detailing assembly of claim 7, wherein the architectural detailing comprises a core and an outer covering disposed on at least a portion of the core, wherein the core has an end surface having a perimeter profile that substantially matches a perimeter profile of the first planar wall.

9. The architectural detailing assembly of claim 7, wherein the architectural detailing comprises a core made from a preselected material and an outer covering disposed on at least a portion of the core, wherein the spacer is also made from the preselected material.

10. The architectural detailing assembly of claim 7, wherein a surface area of the first planar wall of the spacer is between less than 100% and more than about 70% of a surface area of the end surface of the architectural detail.

11. The architectural detailing assembly of claim 7, wherein a surface area of the first planar wall of the spacer is between less than 100% and more than about 85% of a surface area of the end surface of the architectural detail.

12. The architectural detailing assembly of claim 7, wherein the end surface of the architectural detailing has a predetermined perimeter shape defined partially by the appearance surface, and wherein the first planar wall has a preselected perimeter shape defined partially by the sealant backing surface, and wherein when the predetermined perimeter shape of the architectural detailing is larger than the preselected perimeter shape of the spacer such that when the spacer is coupled to the architectural detail, the portion of the preselected perimeter defined by the sealant backing surface is spaced inward from the portion of the predetermined perimeter defined by the appearance surface.

13. The architectural detailing assembly of claim 7, wherein the end surface of the architectural detailing has a predetermined perimeter shape defined partially by the appearance surface, and wherein the first planar wall has a preselected perimeter shape defined partially by the sealant backing surface which substantially matches the predetermined perimeter shape of the architectural detailing except that a portion of the preselected shape defined by the sealant backing surface is spaced inward from a portion of the predetermined shape defined by the appearance surface.

14. A method of forming an architectural detailing assembly comprising:
(a) extruding a first core having a predetermined profile;
(b) covering at least one surface of the first core with a finish material to enlarge the predetermined profile of the first core to a selected profile;
(c) extruding a second core having the predetermined profile and a length; and
(d) cutting the second core substantially perpendicular to its length to form one or more spacers having the predetermined profile.

15. The method of claim 14, further including extruding the first and second cores from a foam material.

16. The method of claim 14, wherein the finish material is a cementitious compound.

17. The method of claim 14, wherein a thickness of the one or more spacers is less than about one inch.

18. The architectural detailing assembly formed by the method of claim 14.

19. A method of forming an architectural detailing assembly comprising:
(a) attaching an architectural detailing to a structure, the architectural detailing having a core which has a predetermined profile and a covering applied to at least a portion of an outer surface of the first core which enlarges the predetermined profile to a preselected profile;
(b) coupling a spacer having substantially the predetermined profile to an end surface of the architectural detailing; and
(c) placing a sealant upon the spacer and architectural detailing to seal the architectural detailing to the spacer.

20. The method of claim 19, further comprising extruding the core and the spacer so that each has the predetermined profile.

21. The method of claim 19, further comprising extruding the core and the spacer from a foam material.
